(19) United States
(12) Patent Application Publication
(10) Pub. No.: US 2023/0269220 A1
(43) Pub. Date: Aug. 24, 2023

(54) METHODS AND APPARATUS FOR DISTRIBUTION OF DYNAMIC MAC ADDRESSES

(71) Applicant: interDigital Patent Holdings, Inc., Wilmington, DE (US)

(72) Inventors: Antonio de la Oliva, Madrid (ES); Ulises Olvera-Hernandez, Saint-Lazare (CA); Robert Gazda, Spring City, PA (US)

(21) Appl. No.: 18/020,667

(22) PCT Filed: Aug. 12, 2021
(86) PCT No.: PCT/US2021/045793

§ 371 Date: Feb. 10, 2023

Related U.S. Application Data
(60) Provisional application No. 63/065,202, filed on Aug. 13, 2020.

(51) Int. Cl. H04L 61/5038; H04L 61/5069; H04W 8/26; H04L 61/59

(52) U.S. Cl. CPC H04L 61/5038; H04L 61/5069; H04W 8/26; H04L 61/59; H04L 2101/622

(57) ABSTRACT

Method, apparatus, and systems for distribution of dynamic MAC addresses are provided. For example, a method implemented by a wireless transmit/receive unit (WTRU) for wireless communications includes receiving a message including port management information, determining configuration information from the port management information, where the configuration information indicates at least information related to a set of unicast or multicast addresses, and forwarding the configuration information to configure a Proxy using the information related to the set of unicast or multicast addresses.

### CROSS-REFERENCE TO RELATED APPLICATION(S)

This application claims priority to and the benefit of U.S. Provisional Application No. 63/065,202 filed in the U.S. Patent and Trademark Office on Aug. 13, 2020, the entire contents of which being incorporated herein by reference as if fully set forth below in its entirety and for all applicable purposes.

### SUMMARY

The disclosure generally relates to communication networks, wireless and/or wired. One or more embodiments disclosed herein are related to methods and apparatus for distribution of dynamic MAC addresses. For example, mechanisms for IEEE 802.1CQ distribution of dynamic MAC addresses in 3GPP virtual TSN bridges are provided.

In one embodiment, a method implemented by a wireless transmit/receive unit (WTRU) for wireless communications includes receiving a message including port management information, determining configuration information from the port management information, where the configuration information indicates at least information related to a set of unicast or multicast addresses, and forwarding the configuration information to configure a Proxy using the information related to the set of unicast or multicast addresses.

In another embodiment, a method implemented by a wireless transmit/receive unit (WTRU) for wireless communications includes determining that an update of a set of unicast or multicast Medium Access Control (MAC) addresses is needed, triggering, based on a determination that the update of the set of unicast or multicast MAC addresses being needed, a protocol data unit (PDU) session establishment procedure or a PDU session modification procedure to send port management information, and sending the port management information, where the port management information comprises information indicating the update of the set of unicast or multicast MAC addresses being needed.

In one embodiment, a WTRU comprising a processor, a transmitter, a receiver, and/or memory may be configured to implement the method disclosed herein. For example, the WTRU may be configured to receive a message including port management information, to determine configuration information from the port management information, and the configuration information indicates at least information related to a set of unicast or multicast addresses, and to send or forward the configuration information to configure a Proxy using the information related to the set of unicast or multicast addresses.

In another example, the WTRU may be configured to determine that an update of a set of unicast or multicast Medium Access Control (MAC) addresses is needed, to trigger, based on a determination that the update of the set of unicast or multicast MAC addresses being needed, a protocol data unit (PDU) session establishment procedure or a PDU session modification procedure to send port management information, and to send the port management information, where the port management information comprises information indicating the update of the set of unicast or multicast MAC addresses being needed.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures and the detailed description are not to be considered limiting, and other equally effective examples are possible and likely. Furthermore, like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a system diagram illustrating a simplified architecture of 3GPP TSN model, according to one or more embodiments;

FIG. 3 is a system diagram illustrating an example of a fully centralized model as specified in IEEE 802.1Qcc, according to one or more embodiments;

FIG. 4 is a message flow diagram illustrating an example of a self-claim PALMA procedure, according to one or more embodiments;

FIG. 5 is a message flow diagram illustrating flow message exchange of a server-based allocation procedure, according to one or more embodiments;

FIG. 6 is a system diagram illustrating an architecture of IEEE 802 networks interconnected via a 3GPP network using PALMA protocol, according to one or more embodiments;

FIG. 7 is a message flow diagram illustrating a first example of handling the process of the PALMA protocol, according to one or more embodiments;

FIG. 8 is a message flow diagram illustrating a second example of handling the process of the PALMA protocol, according to one or more embodiments; and

FIG. 9 is a message flow diagram illustrating an exemplary operation of PALMA Proxy (configuration and configuration update), according to one or more embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

Various embodiments provided herein describe different mechanisms for optimization of the IEEE 802.1CQ [1] (e.g., protocol for assignment of local and multicast addresses (PALMA)) in IEEE 802 networks interconnected through 3GPP Ethernet Protocol Data Unit (PDU) sessions and/or through 3GPP Time Sensitive Communications.

### Communications Networks and Devices

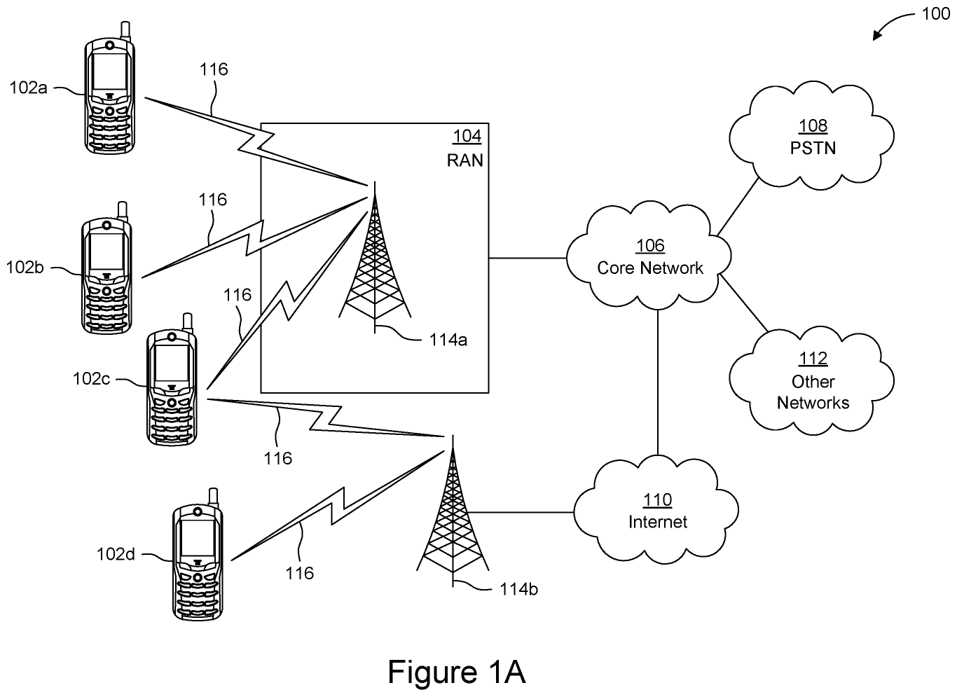

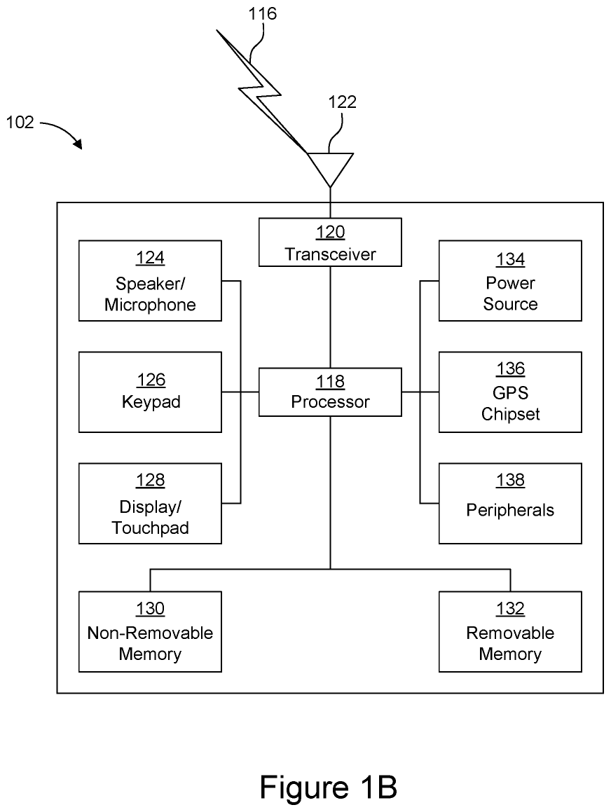

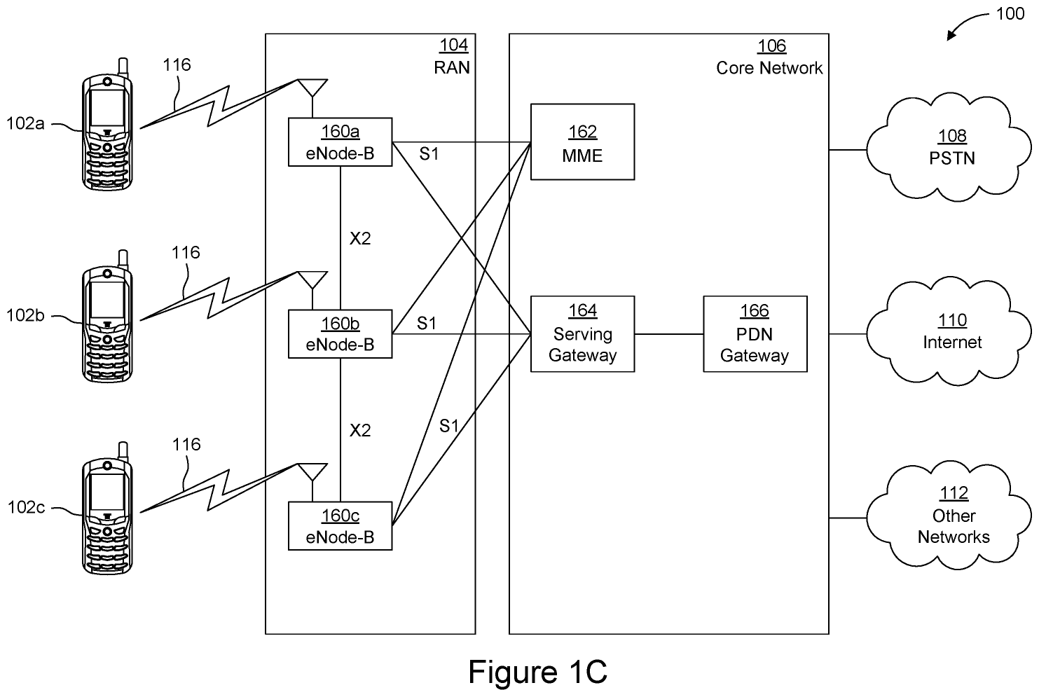

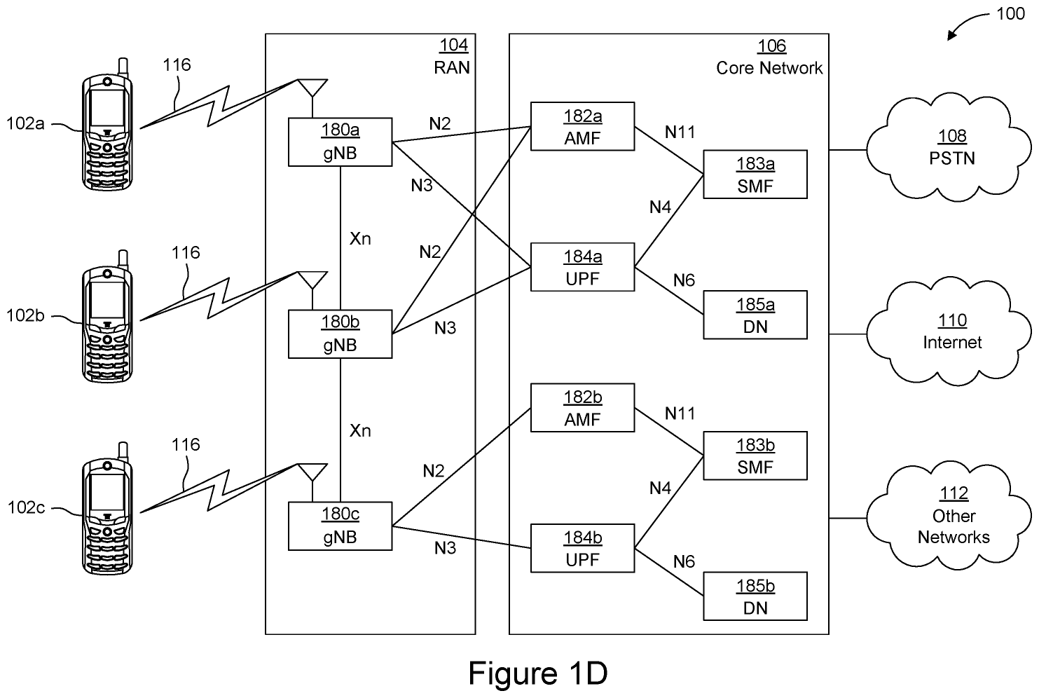

The methods, apparatuses and systems provided herein are well-suited for communications involving both wired and wireless networks. Wired networks are well-known. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a New Radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, e.g., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (e.g., Wireless Fidelity (WiFi), IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, a Home Node B, a Home eNode B, or an access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR, etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11 ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 182 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### 3GPP Time Sensitive Networking (TSN)

The 3rd Generation Partnership Project (3GPP) has defined an architecture and one or more mechanisms for interconnecting IEEE 802.1 TSN islands through a 3GPP network, which enables not only the transport of TSN flows but also the synchronization of clocks and maintenance of clock synchronization across the networks.

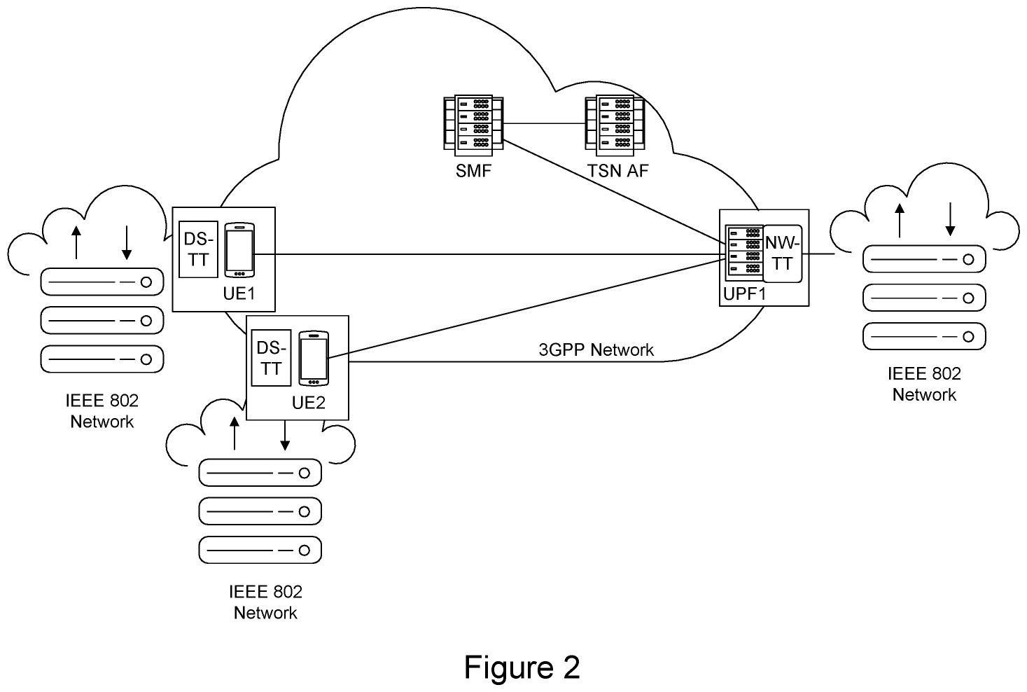

In an example, FIG. 2 illustrates an architecture defined in 3GPP TS 23.501[2]. In this example, a 5G system is integrated with an external network as a logical TSN bridge. The architecture in FIG. 2 includes two translators in charge of interoperation between an TSN system and the 5G system, for both user plane and control plane. The two translators are Device Side Translator (DS-TT) and Network Translator (NW-TT) [7]. The 5G system-specific procedures (e.g., in a 5G core network (5GC) and a radio access network (RAN), wireless communication links) remain hidden from the TSN network. To achieve such transparency to the TSN network, the 5G system appears as any other TSN bridge(s), by providing TSN ingress and egress ports via DS-TT and/or NW-TT.

In some examples, DS-TT and/or NW-TT may optionally support: 1) hold and forward functionality for the purpose of de-jittering; and 2) per-stream filtering and policing as defined in IEEE 802.1Q [3]. In addition, DS-TT optionally supports link layer connectivity discovery and reporting as defined in IEEE 802.1AB [4] for discovery of Ethernet devices attached to DS-TT. NW-TT supports link layer connectivity discovery and reporting as defined in IEEE 802.1AB for discovery of Ethernet devices attached to NW-TT.

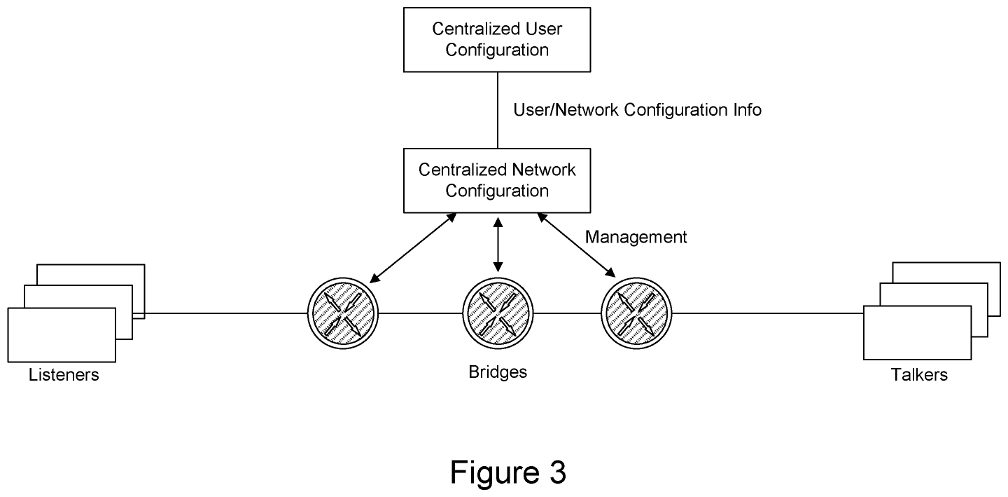

In some current implementations, a 3GPP model for supporting the interconnection of TSN networks assumes/uses a fully centralized model as defined in IEEE 802.1Qcc [5]. This model is characterized by two entities in charge of configuration of all parameters in the network, as described in FIG. 3. The network configuration information is directed to and/or from a Centralized Network Configuration (CNC) entity. All configuration of bridge(s) for TSN streams is performed by this CNC using a remote network management protocol, such as Network Configuration Protocol (NETCONF), Simple Network Management Protocol (SNMP), and/or Representational State Transfer Configuration Protocol (RESTCONF).

The CNC has a complete view of the physical topology of the network as well as the capabilities of each Bridge, which enables the CNC to centralize complex computations. In some examples, the CNC can be in either an end station or a Bridge.

The end user stations and their requirements in terms of flows are directed to/from a Centralized User Configuration (CUC) entity. The CUC is responsible of discovering end stations, retrieving end station capabilities and user requirements, and configuring TSN features in end stations.

This 3GPP model, known as the fully centralized model as specified in IEEE 802.1Qcc, has several advantages, as this model supports all the scheduling features defined in the TSN family of standards. However, the centralized model requires of modifications and/or third-party support of systems to configure the end users and their flows. TSN has defined two other modes of operation for a TSN network: a fully distributed model, and a centralized network/distributed user model.

### PALMA (IEEE 802.1CQ) Protocol

PALMA may be used for different reasons within a network. First, PALMA protocol may be used for acquiring a MAC address to the client interfaces. Second, the PALMA protocol can be used to allocate multicast MAC addresses, which among others, may be used to as stream identifiers for TSN streams.

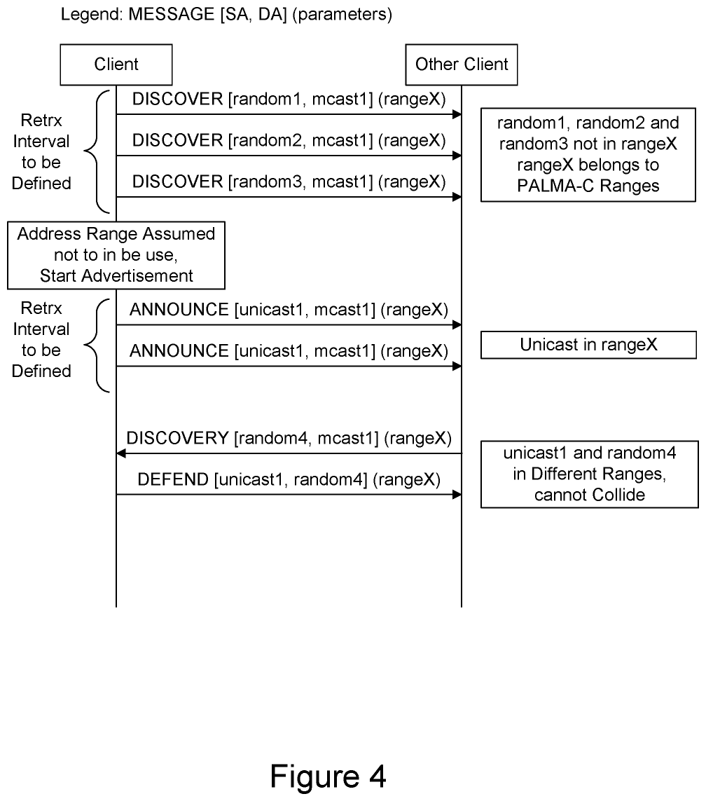

The PALMA protocol may operate in any of the following two differentiated mechanisms: self-claim or server-allocated. In some examples, self-claim can operate without any support from the infrastructure, or with support from a Proxy/Server. FIG. 4 illustrates an example of a self-claim PALMA procedure. In this self-claim PALMA procedure, the protocol starts by the client selecting a range of addresses to be used. The client may send multiple DISCOVER messages, spaced by some time (e.g., a predefined or predetermined time duration). Each of the DISCOVER messages may be sent with a randomized source MAC address.

In case the DISCOVER messages are not answered by any DEFEND message, the client may assume the MAC range is free and proceed with the self-assignment to the client itself. At this point of time, the client may start defending its allocations by issuing periodic ANNOUNCE message(s).

Still referring to FIG. 4, the procedure also illustrates an example of a client trying to allocate an address being used by another client. In this case, a DISCOVER message being received (e.g., by the client from the other client, as shown in FIG. 4) includes a range of addresses previously allocated by the receiving client. The receiving client sends a DEFEND message to the requesting client (source MAC address is the unicast address of the client sending the DEFENSE message and destination is the source MAC address of the DISCOVER message), indicating that this range of addresses is already in use. The requesting client (e.g., the other client in FIG. 4), after receiving the DEFEND message, may restart operations, for example, choosing a different MAC range, and/or performing another DISCOVER process.

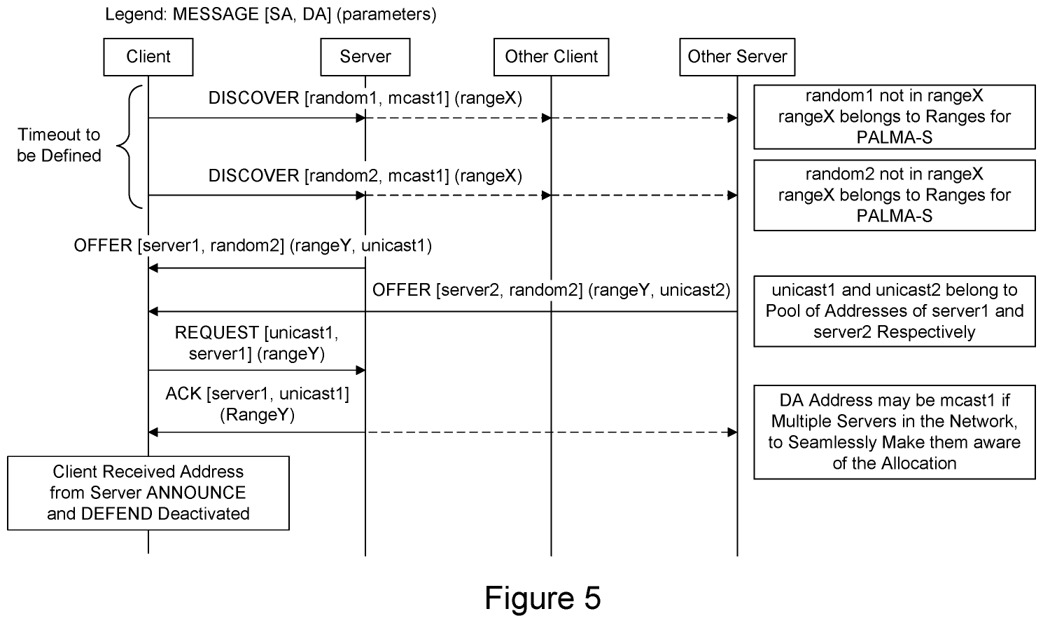

FIG. 5 illustrates an example of a procedure of flow messages exchange for a server-based allocation. In this example, the server-based allocation starts with a DISCOVER message requesting for a MAC range. The DISCOVER message is sent, for example, following the same rules as in a self-claim case (e.g., the self-claim PALMA procedure illustrated in FIG. 4), using a random address (e.g., a random MAC address) as the source address and a multicast address (e.g., a multicast MAC address) as the destination address, and retransmitting the DISCOVER message as in the self-claim case.

As shown in FIG. 5, if one or more PALMA servers or proxies (referred as “servers”) are located in the network, at least one of the servers may answer with an OFFER message. The OFFER message is destined to the unicast random address source of the DISCOVER message. Multiple OFFER messages may be received if multiple PALMA servers/proxies are available in the network. For example, if the network comprises multiple servers, each server may answer with a respective OFFER message to a respective DISCOVER message from a requesting client. After selecting the OFFER that better fits the requirement(s) of the client, the client issues/sends a unicast REQUEST message to the server (e.g., a server selected based on one or more received OFFER messages), including the range of addresses that the client requested for allocation (e.g., this range must be coherent with the MAC range advertised in the REQUEST message). In case the OFFER messages received do not meet the requirements from the client, the client may issue a new DISCOVER message with a modified range of MAC addresses, in this case, the procedure of the server-based allocation is restarted.

In an example, the procedure may end by the server confirming the allocation of addresses by an acknowledgement (ACK) message. In some cases, this ACK message may be sent in unicast to the client (e.g., in case only one server is present in the network) or in multicast to advertise the new allocation to the rest of servers in the network.

In some examples, once the ACK message is received by the client, the client may delay or deactivate DEFEND and/or ANNOUNCE procedures (e.g., not sending DEFEND and/or ANNOUNCE message(s)). For example, in order to orchestrate the client(s) working under the self-claiming mechanism and/or the server-based mechanism, client(s) receiving the MAC address range allocation through a server should not perform DEFEND and/or ANNOUNCE procedures. The DEFEND procedures may be offloaded to the server which would decline allocation of addresses already leased to client(s).

IEEE 802.1CQ (e.g., PALMA protocol) enables the configuration of MAC addresses to IEEE 802 end stations. The protocol specifies two mechanisms for the MAC address allocation, self-claiming and server-based. Both mechanisms require multicast communications. In case an IEEE 802 network includes two IEEE 802 islands which are connected through a 3GPP network, it may incur in a high overhead and may be optimized.

As shown in FIG. 4 and/or FIG. 5, a PALMA procedure assumes all clients to be able to receive multicast messages for both self-claiming and server-based allocation procedures, requesting for the allocation of a MAC range. In case an IEEE 802 network is connected through an Ethernet PDU Session or through a TSN virtual bridge, there may be multicast traffic that needs to be forwarded to all different IEEE 802 islands connected through the 5G system (5GS), e.g., the UPF may need to send the DISCOVER messages to several WTRUs in charge of retransmitting the information on the IEEE 802 networks they are attached to. In addition, the IEEE 802.1CQ server can be deployed in one of the IEEE 802 islands connected by the 5GS, and in case the delay in the 3GPP network is high, problems within the PALMA protocol would occur. In some cases, a DISCOVER message may use a randomly generated MAC address (in general) as a source address, leading to a more complex scenario where the identification or filtering of DISCOVER message(s) cannot be done based on the source MAC address.

In some examples, the use of PALMA enables administrators to define their own strategy for Local MAC allocation, and therefore, the administrators are able to provide structured plans or even novel MAC-semantic based applications to the network.

As such, new or enhanced methods and mechanisms are desired for the deployment and configuration of PALMA servers/proxies such that the overhead created within the 3GPP network by the use of PALMA is (e.g., highly) reduced, while still enjoying the benefits provided by the PALMA protocol.

### Representative Procedure for Operation(s) of PALMA in IEEE 802 Networks Interconnected by 5G System(s)

In various embodiments, new or improved procedures and/or operations for deployment of IEEE 802.1CQ on IEEE 802 networks interconnected through 5GS are provided.

PALMA in IEEE 802 Networks Interconnected Via 5GS Through 5GLAN PDU Sessions

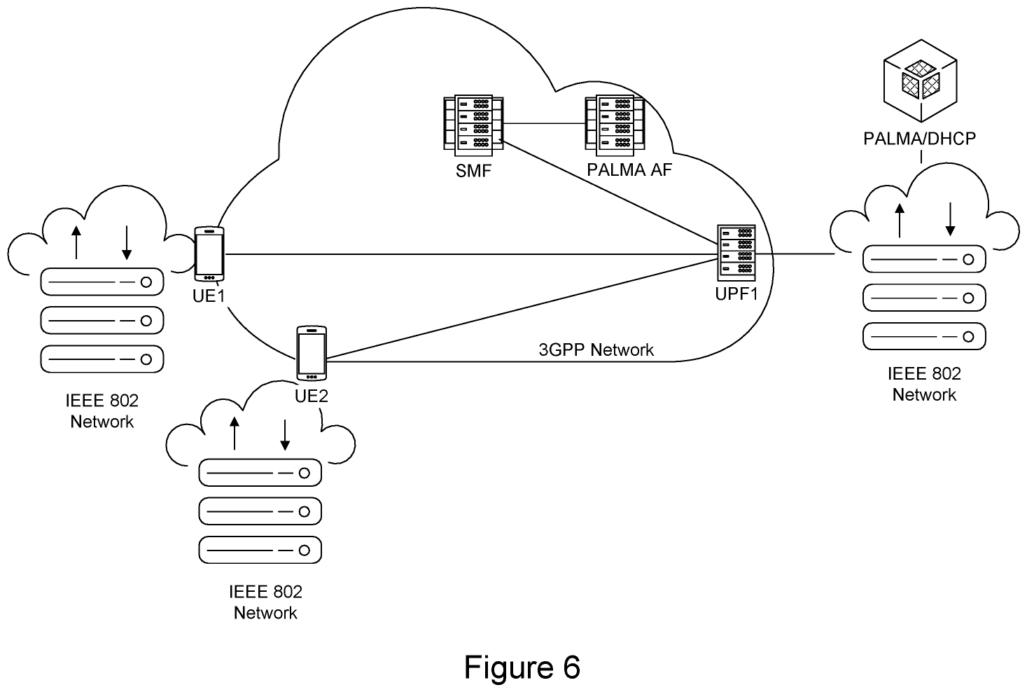

In one embodiment, referring to FIG. 6, in a general deployment, several IEEE 802 networks may be connected between themselves through a 5G system. In this embodiment, 5GLAN services may be considered, while TSN inside the 5G network may not be considered. In this embodiment, FIG. 6 illustrates some key elements of this embodiment. The elements of this embodiment may encompass three IEEE 802 islands connected through an Ethernet PDU session (e.g., which end-points are UE1, UE2, and UPF1). This embodiment also considers that an Application Function (AF) and a Session Management Function (SMF) control the User Plane Function (UPF). One of the IEEE 802 networks being connected contains a PALMA/Dynamic Host Configuration Protocol (DHCP) server that is able to allocate MAC addresses for the whole network.

First, the 3GPP network (e.g., the 5G system) must contain an AF that provides support for the PALMA protocol. This AF may be collocated with the TSN AF or may be implemented separately. This AF may be referred to as a PALMA AF. In some examples, the PALMA AF may be in charge of using the PALMA protocol (or the extensions to DHCP) defined in [6] to obtain a range of MAC addresses, and these MAC addresses are to be allocated to PALMA clients (connected to the WTRUs), providing the PALMA clients with access to the 3GPP network (e.g., used to connect different IEEE 802 islands).

In one embodiment, once the PALMA AF obtains the range of MAC addresses, the PALMA AF may either behave as a PALMA Proxy or delegate this functionality to other elements in the network.

In one embodiment, the PALMA protocol may determine, select, or segregate the use of self-claiming or server-based mechanism based on the range of addresses (e.g., MAC addresses) being requested. For example, the AF (e.g., a PALMA AF) may choose to always block the PALMA messages that request a self-claim address and always provide a server-based address allocation, in order to reduce the possible multicast signaling on its network. Various embodiments assume that the PALMA AF (or an entity to which the PALMA AF has delegated this functionality) receives a DISCOVER message requesting an address belonging to the range of self-claiming MAC addresses, and the PALMA AF (or the entity having delegation) may answer or respond the requesting peer following a server-based procedure disclosed herein.

In various embodiments, multiple mechanisms are provided to handle the process of the PALMA protocol.

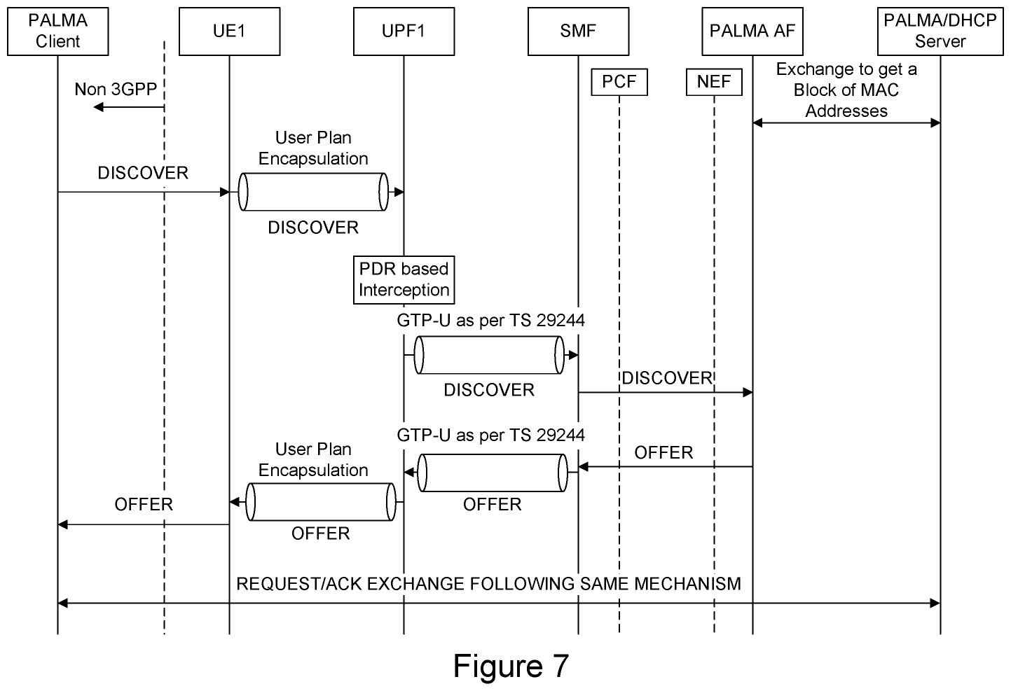

In one embodiment, a mechanism using UPF/SMF as a PALMA bridge is provided. For example, the UPF may intercept one or more PALMA messages (e.g., filtering the multicast address the PALMA messages are sent to) and forward these packets (e.g., including PALMA messages) to the SMF which interacts with the AF for its processing. Referring to FIG. 7, in an example, the mechanism may comprise communications that start by a PALMA client (e.g., located in an Ethernet station) generating a DISCOVER message to start/initiate the allocation of a MAC address. This DISCOVER message may be requesting an address belonging to the self-claiming space or to the server-based allocation indistinctively. In an example, this DISCOVER message is encapsulated at layer 2 (L2) and may not necessarily contain an IP header. The DISCOVER is forwarded by UE1 (a WTRU), as a user plane frame encapsulated in the user plane encapsulation used within the 5GS. Once the DISCOVER reaches the UPF assigned to this PDU session, UPF1 applies a Packet Detection Rule (PDR), or a Protocol Discriminator (PDI) matching the EtherType used by the PALMA protocol, which indicates the UPF to encapsulate the frame in a GPRS Tunneling Protocol User Plane (GTP-U) tunnel to send the frame to the SMF. The SMF may process the packets and decide to forward the packet or frame to the PALMA AF (e.g., the PALMA AF in charge of PALMA address allocation for this specific network). The communications between the SMF and the AF may go directly through a Policy Control Function (PCF) or through a Network Exposure Function (NEF). The OFFER process may be performed in the reverse direction, going through the PALMA AF (e.g., PCF, NEF) to the SMF, who sends the OFFER message to the UPF, which in turn forwards it to the WTRU. The WTRU forwards the OFFER to its destination outside the 3GPP network (e.g., within the 802 island(s) beyond the WTRU). The rest of the PALMA exchange (e.g., REQUEST and/or ACK) through the 3GPP network, may be performed following the same procedure as disclosed above.

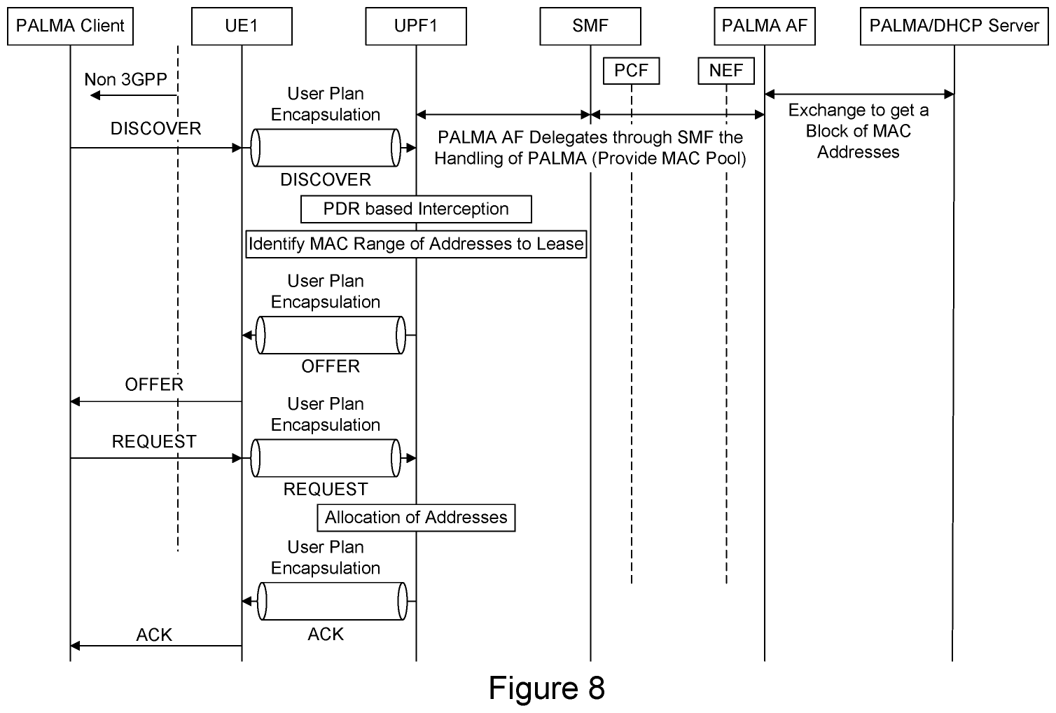

In one embodiment, referring to FIG. 8, a mechanism using UPF as a PALMA Proxy is provided. In this example, the AF (e.g., a PALMA AF) may delegate the PALMA operations to an UPF, in the same way that Address Resolution Protocol (ARP) responses being delegated to the UPF as per TS 23.501. In this case, the PALMA AF through the SMF (e.g., this communication may involve the PCF and/or NEF) may configure a pool of MAC addresses in the UPF. The SMF may configure a PDR at the UPF and a Forwarding Action Rule (FAR) that has a new PALMA Proxy bit in Proxying IE of the Forwarding Parameters IE set to “1” or a PDI matching the EtherType used by the PALMA protocol. Upon reception of a DISCOVER message, the UPF may act as a PALMA Proxy with a delegated pool of addresses (e.g., MAC addresses). The UPF (or a PALMA Proxy) may process the DISCOVER message and answer/respond to an OFFER message, offering a set of addresses from its pool. In case the addresses requested cannot be provided by the UPF delegated function, communications using a similar mechanism (e.g., the mechanism using UPF/SMF as a PALMA bridge provided above) is possible. The procedure and exchange may end and/or be considered as finished, and the usual PALMA protocol with a REQUEST and ACK message exchange may be followed (or resumed).

PALMA in IEEE 802 Networks Interconnected Via 5GS Time Sensitive Communications

In some previous embodiments, one or more mechanisms are related to IEEE 802 networks being connected through generic 5G Ethernet PDU session(s). In addition to these mechanisms, 3GPP has also defined mechanisms for the interconnection of IEEE 802 network which are Time Sensitive (e.g., TSN). For these networks, the system includes two new 3GPP entities, DS-TT and NW-TT. Taking into consideration these new entities in the network, new mechanisms may provide extensions to the information used on the configuration mechanism of the DS-TT and NW-TT, so that a PALMA Proxy can be configured in the DS-TT and/or NW-TT. In addition, these informational extensions can be used to communicate the PALMA Proxy at the DS-TT/NW-TT and the PALMA AF through, for example, NAS signaling.

In various embodiments, configuration of the DS-TT and NW-TT is performed by the transfer of Ethernet port management information between the TSN AF and the DS-TT at the WTRU, to manage the Ethernet port used at the DS-TT for a PDU session having an “Ethernet” PDU session type. The Ethernet port management messages are included in a Port management information container IE and transported using the PDU session establishment procedure and PDU session modification procedure as specified in 3GPP TS 23.502 [8]. Similar behavior may apply to the NW-TT.

The communications between the DS-TT/NW-TT and the TSN AF are specified in TS 24.519 [7], which defines the different commands an AF can send to the DS-TT and NW-TT within a Port management information container. In various embodiments, information elements (IEs) in the Port management information container may be modified to include one or more MAC address range pools and the possibility to activate the PALMA proxy behavior in the DS-TT or NW-TT. In this case, the network may be able to place the PALMA proxy near the clients requesting MAC address(es), reducing the load in the network and reducing the delay required to obtain the MAC address(es).

The Port management information container is specified in TS 23.501 (e.g., in Section 5.28.3), specifically in Table 5.28.3.1-1 Standardized port management information. In one embodiment, to be able to configure the PALMA Proxy, some or all of the following information (as shown in Table 1) may be included or added, for example, in the Port management information container.

TABLE 1
Table 5.28.3.1-1 of TS 23.501 being modified to include PALMA configuration

| | Applicability | | Supported | |
|---|---|---|---|---|
| | (see Note 6) | | operations | |
| | DS- | NW- | by TSN AF | |
| Port management information | TT | TT | (see Note 1) | Reference |
| General | | | | |
| Port management capabilities | X | X | R | |
| (see Note 2) | | | | |
| Bridge delay related information | | | | |
| txPropagationDelay | X | X | R | IEEE 802.1Qcc [95] |
| | | | | clause 12.32.2.1 |
| Traffic class related information | | | | |
| Traffic class table | X | X | RW | IEEE 802.1Q [98] |
| | | | | clause 12.6.3 and |
| | | | | clause 8.6.6. |
| . . . (several rows) | | | | |
| PSFPAdminCycleTime | X | X | RW | IEEE 802.1Q [98] |
| | | | | Table 12-33 |
| PSFPTickGranularity | X | X | R | IEEE 802.1Q [98] |
| | | | | Table 12-33 |
| IEEE 802.1CQ | | | | |
| PALMA Listening Address | X | X | RW | IEEE 802.1CQ |
| Unicast MAC Address range | X | X | RW | IEEE 802.1CQ |
| (NOTE 11) | | | | |
| Multicast MAC Address range | X | X | RW | IEEE 802.1CQ |
| (NOTE 11) | | | | |
| Network information | X | X | RW | IEEE 802.1CQ |
| Server Identifier | X | X | RW | IEEE 802.1CQ |
| More Addresses needed | X | X | RW | Flag indicating that the |
| | | | | DS-TT or NW-TT |
| | | | | PALMA proxy requires |
| | | | | more addresses |

NOTE 7:
NW-TT uses Static Filtering Entry information to determine the NW-TT egress port for forwarding UL TSC traffic.
NOTE 8:
There is a Stream Filter Instance Table per Stream.
NOTE 9:
There is a Stream Gate Instance Table per Gate.
NOTE 10:
The use of PSFP information is mandatory at the TSN AF and is optional at both DS-TT and NW-TT. TSN AF uses the PSFP information at TSN bridge configuration time to identify the DS-TT MAC address of the PDU Session as described in clause 5.28.2 and for determination of the TSCAI information as described in Annex I. The PSFP information can be used at the DS-TT (if supported) and at the NW-TT (if supported) for the purpose of per-stream filtering and policing as defined in IEEE 802.1Q [98] clause 8.6.5.1.
NOTE 11:
Multiple Unicast and Multicast MAC Address ranges can be provided to the DS-TT and the NW-TT

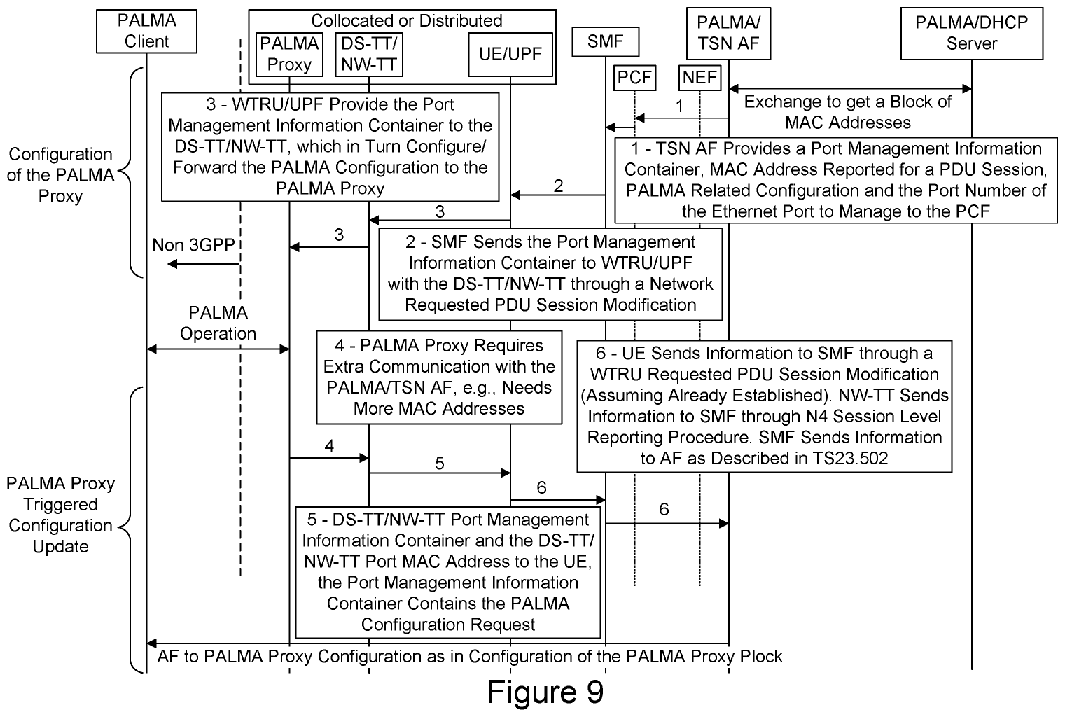

In one embodiment, the operation of the PALMA Proxy at the logical ports of a virtual TSN bridge provided by the 3GPP TSC, is shown in FIG. 9. It is assumed that the PALMA AF and TSN AF are collocated, but it is not assumed that anything regarding the location of the UE/UPF, the location of DS-TT/NW-TT, and the location of PALMA Proxy. In some examples, UE/UPF, DS-TT/NW-TT, and/or PALMA Proxy may be implemented in a same entity. In other words, the placement of the WTRU, UPF, DS-TT/NW-TT, and PALMA Proxy may be based on implementation or be flexible in terms of placement/locations. For example, the DS-TT may be implemented within a WTRU, and the PALMA Proxy may be also within the WTRU. Still referring to FIG. 9, communications between the AF and the SMF may be based on implementation and may be flexible. In some cases, the operation may enable communications through the PCF and/or through the NEF, if needed.

In various embodiments, the configuration of the PALMA Proxy sequence may include any of the following operations:

The PALMA AF (e.g., collocated with TSN AF) may gather configuration of PALMA resources through DHCP or IEEE 802.1CQ communications with a central PALMA server for the TSN network being interconnected.

The AF may include one or more parameters (and/or configurations) in a Port Management Information Container (e.g., as modified in Table 1), for example, the MAC address reported for a PDU Session, the PALMA (or PALMA-related) configuration, and/or the port number of the Ethernet port to be (or being) managed by the PCF. The PCF may manage a virtual bridge based on the port number. In an example, the port number is the identifier of the virtual bridge being managed. The PCF may forward the information (e.g., in the Port Management Information Container) to SMF based on the MAC address using the PCF initiated SM Policy Association Modification procedure as described in 3GPP TS 23.502 (e.g., in FIG. 4.16.5.1-1 of TS 23.502). SMF may determine whether the port number relates to a DS-TT or NW-TT Ethernet port, and based on this determination, the SMF may forward the Port Management Information Container to DS-TT or NW-TT using the network requested PDU Session Modification procedure as described in TS 23.502, FIG. 4.3.3.2-1.

Upon reception of the information in the Port Management Information Container, the UE/UPF may forward this information to the DS-TT/NW-TT which configures the PALMA Proxy. The PALMA Proxy may or may not be collocated. In some examples, the Port Management Information Container may include configurations to configure any of the DS-TT/NW-TT and the PALMA Proxy.

In various embodiments, upon configuration of the PALMA Proxy, all requests from clients in the TSN networks may be answered/responded locally by the PALMA Proxy, which has been configured by the TSN/PALMA AF.

In case modification of the configuration (e.g., Configuration Update) is needed (e.g., the pool of addresses given to the PALMA Proxy is exhausted), the following process may be followed (e.g., a PALMA Proxy triggered configuration update block):

In case the PALMA Proxy is attached to a DS-TT, the DS-TT may provide a Port Management Information Container (as amended in Table 1) and the MAC address of the DS-TT port to the WTRU (or UE), which includes the Port Management Information Container as an optional Information Element (IE) of an N1 SM container and triggers the WTRU requested PDU Session Establishment procedure/PDU Session Modification procedure to forward the Port Management Information Container to the SMF. The SMF may forward the Port Management Information Container and the port number of the related DS-TT Ethernet port to a TSN AF, as described in TS 23.502.

In case the PALMA Proxy is attached to a NW-TT, the NW-TT may provide a Port Management Information Container to the UPF, which triggers the N4 Session Level Reporting Procedure (FIG. 4.4.2.2-1 of TS 23.502) to forward the Port Management Information Container to SMF. The SMF in turn may forward the container and the port number of the related NW-TT Ethernet port to TSN AF as described in TS 23.502.

After finalization of this procedure, the data has arrived at the AF which may use the same mechanism as explained in the Configuration of the PALMA Proxy block to convey the new configuration to the PALMA Proxy.

Each of the following references are incorporated by reference herein: [1] IEEE 802.1CQ—(Draft) Standard for Local and Metropolitan Area Networks: Multicast and Local Address Assignment. [2]3GPP TS 23.501, Rel-16, System architecture for the 5G System (5GS). [3] 802.1Q-2018—IEEE Standard for Local and Metropolitan Area Network—Bridges and Bridged Networks. [4] 802.1AB-2016—IEEE Standard for Local and metropolitan area networks—Station and Media Access Control Connectivity Discovery. [5] 802.1Qcc-2018—IEEE Standard for Local and Metropolitan Area Networks—Bridges and Bridged Networks—Amendment 31: Stream Reservation Protocol (SRP) Enhancements and Performance Improvements. [6] Link-Layer Addresses Assignment Mechanism for DHCPv6, draft-ietf-dhc-mac-assign-05. [7] 3GPP TS 24.519, Rel-16, 5G System (5GS); Time-Sensitive Networking (TSN) Application Function (AF) to Device-Side TSN Translator (DS-TT) and Network-Side TSN Translator (NW-TT) protocol aspects; Stage 3. And [8] 3GPP TS 23.502, Rel-16, Procedures for the 5G System (5GS).

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU 102, UE, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the representative embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (“RAM”)) or non-volatile (e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (e.g., but not always, in that in certain contexts the choice between hardware and software may become significant) a design choice representing cost vs. efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

It is also to be understood that the terminology used herein is for the purpose of describing particular embodiments only, and is not intended to be limiting. As used herein, when referred to herein, the terms “station” and its abbreviation “STA”, “user equipment” and its abbreviation “UE” may mean (i) a wireless transmit and/or receive unit (WTRU), such as described infra; (ii) any of a number of embodiments of a WTRU, such as described infra; (iii) a wireless-capable and/or wired-capable (e.g., tetherable) device configured with, inter alia, some or all structures and functionality of a WTRU, such as described infra; (iii) a wireless-capable and/or wired-capable device configured with less than all structures and functionality of a WTRU, such as described infra; or (iv) the like. Details of an example WTRU, which may be representative of any UE recited herein, are provided below with respect to FIGS. 1A-1D.

In certain representative embodiments, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” or “group” is intended to include any number of items, including zero. Additionally, as used herein, the term “number” is intended to include any number, including zero.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

A processor in association with software may be used to implement a radio frequency transceiver for use in a wireless transmit receive unit (WTRU), user equipment (UE), terminal, base station, Mobility Management Entity (MME) or Evolved Packet Core (EPC), or any host computer. The WTRU may be used m conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the invention has been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

Throughout the disclosure, one of skill understands that certain representative embodiments may be used in the alternative or in combination with other representative embodiments.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WRTU, UE, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits.

The data bits may also be maintained on a computer readable medium including magnetic disks, optical disks, and any other volatile (e.g., Random Access Memory (“RAM”)) or non-volatile (“e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

Although the invention has been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

1-8. (canceled)

9. A method for wireless communications, comprising:
determining that an update of a set of unicast or multicast Medium Access Control (MAC) addresses is needed;
triggering, based on a determination that the update of the set of unicast or multicast MAC addresses being needed, a protocol data unit (PDU) session establishment procedure or a PDU session modification procedure to send port management information; and
sending the port management information, wherein the port management information comprises information indicating the update of the set of unicast or multicast MAC addresses being needed.

10. The method of claim 9, wherein the port management information is included in a port management information container.

11. The method of claim 9, wherein the port management information is sent or forwarded to a time-sensitive network (TSN) application function (AF).

12. The method of claim 9, wherein the port management information is sent or forwarded to a protocol for assignment of local and multicast addresses (PALMA) application function (AF).

13. The method of claim 9, wherein the port management information comprises configuration information for updating a PALMA Proxy.

14. The method of claim 9, wherein the port management information is included in a port management information container and sent to a session management function (SMF).

15. The method of claim 14, wherein the port management information included in the port management information container is forwarded, via the SMF, to a TSN AF or a PALMA AF.

16. The method of claim 15, wherein the port management information included in the port management information container is forwarded to the TSN AF or the PALMA AF directly, or via a policy control function (PCF), or via a network exposure function (NEF).

17-21. (canceled)

22. A wireless transmit/receive unit (WTRU) for wireless communications, the WTRU comprising circuitry, including a transmitter, a receiver, a processor, and memory, configured to:
determine that an update of a set of unicast or multicast Medium Access Control (MAC) addresses is needed;
trigger, based on a determination that the update of the set of unicast or multicast MAC addresses being needed, a protocol data unit (PDU) session establishment procedure or a PDU session modification procedure to send port management information; and
send the port management information, wherein the port management information comprises information indicating the update of the set of unicast or multicast MAC addresses being needed.

23. The WTRU of claim 22, wherein the port management information is included in a port management information container.

24. The WTRU of claim 22, wherein the WTRU comprises a user plane function (UPF) associated with the port management information.

25. (canceled)

26. The WTRU of claim 22, wherein the port management information is sent or forwarded to a time-sensitive network (TSN) application function (AF).

27. The WTRU of claim 22, wherein the port management information is sent or forwarded to a protocol for assignment of local and multicast addresses (PALMA) application function (AF).

28. The WTRU of claim 22, wherein the port management information comprises configuration information for updating a PALMA Proxy.

29. The WTRU of claim 22, wherein the port management information is included in a port management information container and sent to a session management function (SMF).

30. The WTRU of claim 29, wherein the port management information included in the port management information container is forwarded, via the SMF, to a TSN AF or a PALMA AF.

31. The WTRU of claim 30, wherein the port management information included in the port management information container is forwarded to the TSN AF or the PALMA AF directly, or via a policy control function (PCF), or via a network exposure function (NEF).
